(19) United States
(12) Patent Application Publication
(10) Pub. No.: US 2020/0003270 A1
(43) Pub. Date: Jan. 2, 2020

(54) SLEEVE FOR A DAMPER, DAMPER, SYSTEM, MANUFACTURING METHOD FOR A SLEEVE, MANUFACTURING METHOD FOR A DAMPER

(71) Applicant: ACE Stoßdämpfer GmbH, Langenfeld (DE)

(72) Inventors: Dieter WOHLSCHLEGEL, Village Neuf (FR); Christian ALSCHER, Leichlingen (DE); Christian JUNGHANS, Solingen (DE); Scott MCNEIL, Ann Arbor, MI (US); Jörg KÜCHMANN, Haan (DE); Finn LANGE-HASENBECK, Monheim am Rhein (DE)

(21) Appl. No.: 16/482,432

(22) PCT Filed: Feb. 20, 2018
(86) PCT No.: PCT/EP2018/054093

§ 371 Date: Jul. 31, 2019

(30) Foreign Application Priority Data
Feb. 24, 2017 (DE) 10 2017 001 786.7

(51) Int. Cl. F16F 9/346; F16F 9/19; F16F 9/32; F16F 9/48

(52) U.S. Cl. CPC F16F 9/3465; F16F 9/19; F16F 9/3271; F16F 9/3235; F16F 9/3242; F16F 9/48; F16F 2224/0208; F16F 2222/04; F16F 2222/02; F16F 2222/12; F16F 2224/02; F16F 2228/066; F16F 2226/04

(57) ABSTRACT

A substantially tubular sleeve is arranged in a damping space of the damper containing a damping fluid and has at least one recess at least in an inner face of the sleeve. The recess defines a flow channel for the damping fluid for adaptation of the flow impedance (F) for the damping fluid at least in a direction along a longitudinal axis (LA) of the sleeve. The sleeve is rigidly and releasably connected to the outer body by a number of contact surfaces on an outer surface of the sleeve and/or has at least one guide surface arranged on an inner surface of the sleeve for guiding the piston over the travel path (H).

Also disclosed is a system for modular assembly of a plurality of dampers, method of manufacture for a sleeve, and a method of production for a damper.

The invention relates to a substantially tubular sleeve for a damper, in particular an industrial shock absorber.

The invention further relates to a damper, in particular an industrial shock absorber, comprising a substantially tubular outer body for accommodating mechanical and/or thermal loads during operation of the damper, a damping space in the outer body to accommodate a damping fluid and a piston guided along a longitudinal axis of the outer body over a travel path in the outer body. In this case the piston divides the damping space into a first fluid chamber and a second fluid chamber.

Moreover, the invention relates to a system for modular assembly of a plurality of dampers which differ with respect to their damping characteristics.

The invention further relates to a method of manufacture for a sleeve and a method of production for a damper.

The prior art in the case of hydraulic industrial shock absorbers discloses the use of static pressure cylinders which contain a damping fluid, for example a hydraulic oil. The oil displaced by the piston when the piston is driven into the shock absorber is pressed through bores or other openings in the pressure cylinder into an equalising chamber. In this case the impact energy is converted into heat by friction during the damping process.

The European patent document EP 0 831 245 B1 also discloses shock absorbers which use a dynamic pot piston with bores introduced into it. In these types, the piston additionally has the function of a pressure cylinder.

In order not to endanger the mechanical stability of pressurised components of a damper, on the one hand stability-reducing interventions such as bores in static pressure cylinders or pot pistons should be designed to be as small as possible. On the other hand, smaller cross-sections of bores produce a higher flow impedance for the damping fluid so that, when the piston is driven in, a correspondingly higher static and/or dynamic pressure and accordingly a high mechanical and thermal load for the pressure cylinder or pot piston is set. For reasons of stability and safety, pressure cylinders and pot pistons are generally manufactured from a solid blank and from high-strength materials with a large wall thickness. Stability-reducing interventions such as bores in correspondingly thick-walled and hard material are therefore risky and require high manufacturing precision and high expenditure. Moreover, this limits the compactness of the external diameter of the shock absorber body and thus of the entire damper, since the overall size is directly dependent on the external diameter of the thick-walled pressure cylinder or pot piston.

The document DE 103 13 659 B3 discloses a pneumatic damper in which air, as damping fluid, is led past the piston through a groove on an inner surface of the pressure cylinder. Here too, the flow cross-section of the groove must be chosen to be small and the wall thickness of the pressure cylinder must be chosen to be sufficiently large, in order not to endanger the mechanical stability of the damper. Moreover, in order to change the flow behaviour of the damping fluid and thus the damping behaviour of a damper, the entire pressure cylinder together with the groove introduced therein must be replaced. Since the pressure cylinder is designed to accommodate the mechanical and/or thermal loads during the damping process, it constitutes, in particular in so far as the amount of material is concerned, a principal component of the damper for which replacement is not usually economically viable. Therefore with a series of dampers, always only a specific damping behaviour can be achieved.

This results in the technical object of creating a damper which is cost-effective and simple to produce, and can be used more flexibly, more reliably and more efficiently than generic dampers.

The object is achieved by a sleeve according to claim 1 for a damper, a damper according to claim 4, a system according to claim 7, a method of manufacture according to claim 8 for a sleeve and a method of production according to claim 10 for a damper. Advantageous embodiments are set out in the subordinate claims.

A substantially tubular sleeve according to the invention for a damper, in particular for example for a hydraulic industrial shock absorber, is designed to be arranged in a damping space of the damper containing a damping fluid, for example a hydraulic oil. The sleeve can comprise at least one recess, preferably two, three or four recesses, at least in an inner surface of the sleeve. The recess defines a flow channel for the damping fluid for adaptation of the flow impedance for the damping fluid at least in a direction along a longitudinal axis of the sleeve. The recess can be for example a groove, and in particular can act as a constricting groove in the damper. In the context of the present invention “tubular” describes an elongate hollow body with at least one opening in each case on mutually opposing ends of the hollow body, wherein a fluid-conducting connection exists between the openings. For a simple construction with the possibility of combination with standard components, the hollow body can advantageously be straight and/or can have a circular cross-sectional area. For example, a confined installation space can be used more efficiently by non-circular, for example elliptical or angular cross-sectional areas. A simple example for a tubular body is a hollow cylinder which is open on its end faces, possibly with one or more openings. A “substantially” tubular body can exhibit slight deviations from the tube shape, such as for example recesses and/or projections.

The flow channel is advantageously defined by the recess together with an outer body of the damper surrounding the damping space and/or a piston dividing the damping space into a first fluid chamber and a second fluid chamber. If the flow channel is defined through the co-operation of the sleeve with the piston and/or the outer body, the sleeve can be designed to be particularly thin-walled and thus saves on material.

For example, the recess can be delimited by the sleeve in the circumferential direction of the sleeve and can be open in the radial direction of the sleeve, so that the recess constitutes a slot extending through the wall of the sleeve in the direction of the longitudinal axis. If the outer body bears on the outer face of such a slotted sleeve and the piston bears on the inside of the sleeve, a flow channel is defined by the slot enclosed between the piston, the sleeve and the outer body.

Due to the definition of a flow channel through a recess in the sleeve, during operation of the damper the damping fluid can flow to and from between the first and second fluid chambers, so that a movement of the piston along the longitudinal axis is possible without recesses having to be provided in the outer body or the piston for this purpose. Because no recesses or less large recesses have to be introduced into the outer body and into the piston, a higher mechanical stability of the outer body and the piston is achieved. Since there is no intervention in the mechanical integrity of the piston and/or outer body, and in particular no material weak points, material tensions and/or stress concentrations can occur at recesses, the reliability of the damper increases. In this way the outer body and/or the piston can be designed to be lighter and/or smaller with the same mechanical and/or thermal load-bearing capacity, so that for the same loading a damper can be designed to be lighter and/or smaller than in the prior art. Thus the damper is more efficient with respect to the resources used and the installation space occupied. In particular in the case of industrial shock absorbers, which can withstand particularly high loads particularly reliably, the aforementioned advantages relating to reliability and efficiency are very significant. Moreover, a sleeve according to the invention facilitates a more flexible production and use of a damper, since in order to change the damping behaviour it is merely necessary to exchange the sleeve defining the flow channel.

The recess can be modulated along the longitudinal axis in order to set the flow impedance. If the flow channel is defined by the recess together with the piston, this results in a flow channel modulated by the position of the piston along the longitudinal axis and a correspondingly modulated flow impedance between the first and second fluid chambers, since the flow impedance in each case is defined by the part of the recess on which the piston bears. The flow impedance determines the damping force of the damper. Thus with the flow impedance the damping force is also modulated as a function of the piston position and thus can be set as a function of the piston position. Thus the damping force progression can advantageously be designed to be application-specific as a function of the piston position of a damper. For example, a damping force progression can be set which increases from a piston position with unloaded damper to a piston position with the damper at maximum loading, in order on the one hand to gently damp low loads of the damper and on the other hand to avoid damage to the damper at high loads. If a flow channel were only defined by recesses on the piston, no modulation of the flow channel, the flow impedance and the damping behaviour would be possible over the travel path as a function of the piston position.

The recess can be modulated with respect to a shape and/or surface of a cross-section orthogonally to the longitudinal axis, particularly preferably with respect to a width in a circumferential direction of the sleeve and/or a depth in a radial direction of the sleeve. In particular a recess modulated with respect to the width can be produced very simply in terms of manufacturing technology, for example as a continuous slot which is cut through the wall of the sleeve and of which the width increases along the longitudinal axis for example parabolically from one end of the slot to the other end of the slot. If the recess is configured as a continuous slot, the depth of the recess corresponds to the wall thickness of the sleeve.

The recess can be modulated with respect to a position of the recess in a circumferential direction of the sleeve. A modulated position results in a non-straight progression of the flow channel. As a result the flow impedance can be increased and/or a heat transfer between the damping fluid and the damper can be increased, so the resulting heat can be diverted better. Furthermore, depending upon the piston position the flow channel can co-operate with different circumferential regions of the piston, which differ for example in their surface morphology or chemical surface composition in order to modulate the flow dynamics of the damping fluid.

The recess can be modulated with respect to a chemical surface composition and/or surface morphology, for example with a flow-dynamic effect or with respect to the hardness and abrasion characteristics or corrosion characteristics. Due to the surface composition, for example, a frictional force between the flow channel and the damping fluid can be set and acts on the flow impedance. Furthermore, for example, the friction of the damping fluid can be reduced by a particularly smooth surface and/or turbulences can be avoided by a microstructured surface, in order to increase or to reduce the flow impedance at least in some sections.

The recess can have a depth in a radial direction of the sleeve which is less than the wall thickness of the sleeve in the same region of the sleeve. As a result the recess is not continuous through the wall, so that a direct contact between the damping fluid in the recess and the outer body of the damper is avoided. This results in a greater freedom in the choice of material of the outer body, since the material does not have to be compatible with the damping fluid, for example resistant to damping fluid. Instead, the outer body can be optimised exclusively to accommodate mechanical and thermal loads in the damper operation and thus where appropriate can be designed to be smaller, lighter and/or more cost-effective. For simpler production of the sleeve the recess can also be configured to be continuous through the wall, since in this way the recess can, for example, be cut out of the sleeve from an outer face of the sleeve.

The recess can comprise at least one flow-dynamically effective coating. For example, the surface morphology and/or chemical surface composition of the flow channel can be set by a coating, which, as explained above, affects the flow impedance.

The sleeve can be designed in its structure, in particular with respect to a wall thickness of the sleeve and/or a material of the sleeve, to provide more savings on material than necessary with respect to the mechanical and/or thermal load-bearing capacity in the damping operation of the damper, because it does not have to bear the main mechanical and/or thermal load. Thus the sleeve can be designed so that, alone, it would not withstand the loads to be expected in the damping operation. As a result the sleeve can advantageously be produced in a particularly lightweight, thin-walled and/or cost-effective manner.

On an outer surface of the sleeve a number of contact surfaces can be provided for diverting mechanical and/or thermal load into the damper, in particular uniformly distributed over the outer surface of the sleeve. Due to the diversion of mechanical and/or thermal loads, loads which the sleeve alone would not withstand can be diverted to the damper in order to conserve the sleeve. The outer surface of the sleeve can bear on the outer body of the damper for example over a large area, in particular over the entire area, so that a pressure produced in the damping operation in the interior of the sleeve can be diverted to the outer body. Thermal loads can be diverted effectively, for example, by the choice of a sleeve material having high thermal conductivity and/or a small wall thickness of the sleeve.

The sleeve can comprise a metal, preferably a steel, a plastic and/or a composite material. It is also possible that the sleeve comprises a braided fabric and/or a woven fabric, for example made of glass fibres or carbon fibres, for improvement of the mechanical stability and/or thermal conductivity. The sleeve material can be selected in particular with regard to its surface characteristics for setting a friction behaviour relative to the damping fluid and/or the piston. On the other hand, volume characteristics such as a good thermal conductivity and/or mechanical stability may play a subordinate role in the case of a small sleeve wall thickness. As a result, particularly advantageous surface characteristics, for example a high wear resistance and/or chemical resistance to the damping fluid, can be selected in a cost-effective and simple manner.

On an inner surface of the sleeve the sleeve can comprise at least one coating, preferably for setting a friction behaviour relative to a piston of the damper. For example, the sleeve can have a wear-resistant coating and/or a friction-reducing coating on its inner surface, so that the piston can be guided by the sleeve in a low-friction and/or low-wear manner. As a result the service life and reliability of the damper are increased.

On at least one end face of the sleeve, the sleeve can comprise a closure element which closes the interior of the sleeve at one end, preferably in a fluid-tight manner. The damping fluid can be enclosed in the sleeve by one or in particular two closure elements, so that it does not come into contact with other components of the damper. As a result the other components do not have to be designed, for example with respect to their material properties, such as for example corrosion resistance, for contact with the damping fluid, so that they can be optimised more simply for other characteristics, for example a low weight. As a result, the sleeve and the other components can be optimised independently of one another.

The invention further relates to the use of a sleeve according to the invention in a damper.

A damper according to the invention, in particular for example a hydraulic industrial shock absorber, comprises a substantially tubular outer body to accommodate mechanical and/or thermal loads during operation of the damper. The damper further comprises a damping space in the outer body to accommodate a damping fluid, for example a hydraulic oil. Moreover, the damper comprises a piston which is guided along a longitudinal axis of the outer body over a travel path in the outer body, wherein the piston divides the damping space into a first fluid chamber and a second fluid chamber. In the simplest case the outer body has substantially the shape of a hollow cylinder, the inner space of which is at least partially occupied by the damping space. In the damping operation of the damper, the damping fluid is displaced by the piston moving along the travel path and as a result flows from the first fluid chamber into the second fluid chamber or vice versa.

The damper can comprise a substantially tubular sleeve arranged in the damping space, wherein the sleeve is rigidly and preferably releasably connected to the outer body by means of a number of contact surfaces on an outer surface of the sleeve and/or has at least one guide surface arranged on an inner surface of the sleeve for guiding the piston over the travel path. In the simplest case, the entire outer surface of the sleeve forms the contact surface and/or the entire inner surface forms the guide surface. The sleeve and/or the outer body can in each case have the shape of a hollow cylinder, so that the sleeve can be inserted, for example, with a precise fit into the inner space of the outer body. The sleeve can be connected by a number of in particular releasable locking means, for example grooves, springs and/or O-rings, to the outer body.

Because the sleeve has guide faces for the piston, the outer body does not have to be designed, for example in relation to its tribological surface characteristics, for guiding the piston and can be more simply optimised for other characteristics, for example a low weight and/or volume. The sleeve and the outer body can be optimised and/or replaced independently of one another, so that a flexible structure of the damper is achieved. Mechanical and/or thermal loads acting on the sleeve due to the damping fluid and/or the piston can be diverted to the outer body by contact surfaces. As a result the reliability of the sleeve increases. Furthermore, the sleeve can be designed to be particularly lightweight and/or thin in order to increase efficiency without endangering its stability. The thin-walled sleeve can preferably be supported against the inside of the outer body. In the sleeve, which is in particular thin-walled, a high pressure is produced during the damping operation. The sleeve, considered on its own, could be destroyed by this pressure. However, since the sleeve is supported against the inner surface of the outer body, this high pressure can be accommodated. A high possible pressure in the damper, in particular in connection with the largest possible piston diameter, allows a high power consumption of the damper and thus a high efficiency and reliability.

A volume between the sleeve and the piston of the damper can form at least one flow channel connecting the first fluid chamber to the second fluid chamber in a fluid-conducting manner. The flow channel is preferably defined by a recess in an inner surface of the sleeve and/or a groove on an outer surface of the piston. In this case the sleeve is advantageously, a sleeve according to the invention. If the flow channel is defined by the sleeve and/or the piston, the outer body does not have to have any recesses for a flow channel which can impair the mechanical stability of the outer body. As a result, for a given damper load the outer body can be designed to be lighter and/or smaller than in generic dampers. If the flow channel is defined by a recess of the sleeve, this results in the advantage that the flow channel can be modulated with respect to the flow impedance for the damping fluid over the travel path of the piston, so that the damping force can be set as a function of the travel path by the configuration of the flow channel.

The guide face can co-operate in a fluid-tight manner with an outer surface of the piston, for example by the piston bearing on the guide face with a precise fit. As a result an uncontrolled flow of the damping fluid between the first and the second fluid chamber is prevented, so that the damper reliably shows the required damping behaviour.

The guide face and/or the outer surface of the piston can in each case have at least one coating for increasing the thermal conductivity, for reducing friction and/or for reducing wear. The said surface characteristics can be optimised by a corresponding coating independently of the choice of a base material.

The contact surfaces can be connected to the outer body in a thermally conductive manner and/or for mechanical transmission of force and/or can occupy substantially the entire outer surface of the sleeve. Thermal and/or mechanical loads can be diverted from the sleeve to the outer body by a connection designed for thermal conduction and/or for transmission of force. Such a connection is achieved for example in that the contact surfaces bear on on the outer body substantially without a gap. A particularly effective and consistent diversion is possible if the contact surfaces are formed with a large surface area, and in particular occupy the entire outer surface of the sleeve.

The system according to the invention for modular assembly of a plurality of dampers according to the invention which differ with respect to their damping characteristics comprises a number of sleeves which differ in particular with respect to the flow impedance for the damping fluid between the first fluid chamber and the second fluid chamber and a number of further components of the damper, wherein the further components are standardised for each damper of the plurality of different dampers. The further components comprise in particular the outer body and/or the piston of the damper. By the system it is possible to produce, from a limited number of different components, dampers which differ in their damping behaviour with great flexibility, since the sleeve is merely selected according to the specific application, whilst the further components can be the same for each damper. As a result, particularly cost-effective and flexible production and logistics are possible.

Furthermore, the sleeve can also be standardised apart from its recess which defines the flow channel, for example, by producing it from a uniform sleeve blank into which different recesses are introduced depending upon the application and possibly directly at the production site of the damper. This results in a further simplification for production and logistics, since fewer different parts have to be taken into consideration and stored.

The production method according to the invention for a sleeve according to the invention comprises at least the introduction of a recess at least into an inner surface of the sleeve, in particular in the form of a sleeve blank. The introduction can take place in particular by laser cutting, preferably by ultra-short pulse lasers. Differently shaped recesses can be produced in a simple manner, precisely and flexibly by laser cutting. Furthermore, during laser cutting no tool wear occurs, so that the required shape is produced with high reliability. Ultra-short pulse lasers, in particular with a laser pulse duration of less than 100 ps, have the advantage that heating of the sleeve outside the recess, which can lead for example to material elevations and/or material stresses, is avoided. As a result particularly precise machining is possible, so that expensive reworking steps are omitted, and the material is not mechanically weakened by possible tensions. Furthermore the reliability of a damper is not compromised by material elevations possibly protruding into the travel path of a piston.

The method of manufacture can comprise reworking, preferably deburring and/or surface treatment, at least of the recess. A surface treatment can for example comprise a surface hardening and/or a coating for setting an interaction such as a frictional force with the damping fluid.

The method of production according to the invention for a damper according to the invention comprises at least the manufacture of the sleeve of the damper, preferably by a manufacturing method according to the invention and/or from a sleeve blank, and the installation of the sleeve in an outer body of the damper. The sleeve can for example be inserted into the outer body and, where appropriate, can be fastened by a locking means, such as a closure and/or an O-ring in a groove of the outer body.

The method of production can comprise selection of a sleeve from a number of sleeves which differ in particular with respect to the flow impedance for the damping fluid between the first fluid chamber and the second fluid chamber, and in particular can use a system according to the invention. By the selection of a sleeve the damping characteristics of the damper can be set in a simple and flexible manner.

A particular advantage of the invention is that almost any progressions of the damping force can be set flexibly and reliably as a function of the piston stroke of a damper using simple means. In the prior art, on the other hand, complex damper designs are necessary in order to produce a modulated damping force progression. As an example in this connection reference is made to the damping force progression in FIG. 9 of the document DE 103 13 659 B3, which is incorporated here in its entirety by reference. The illustrated progression comes about only through the interaction of a sealing lip of complex shape and a brake cuff with longitudinal beads of the piston and constricting grooves of the cylinder.

The invention is described below with reference to exemplary embodiments which are explained in greater detail with reference to the drawings.

In the drawings:

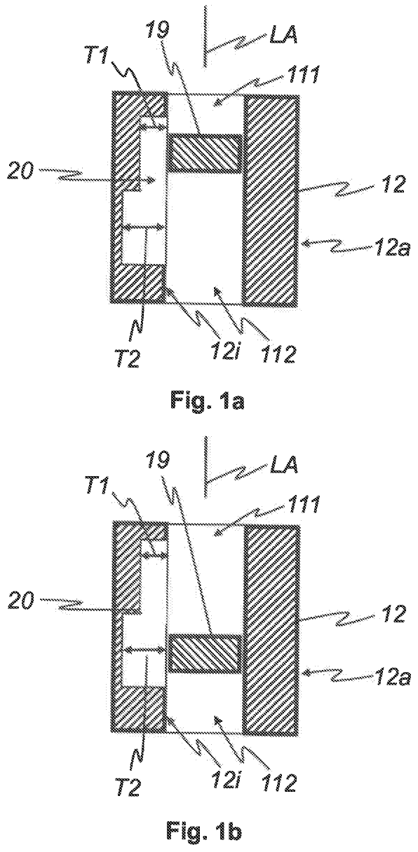

FIG. 1 shows a schematic longitudinal section through a sleeve according to the invention;

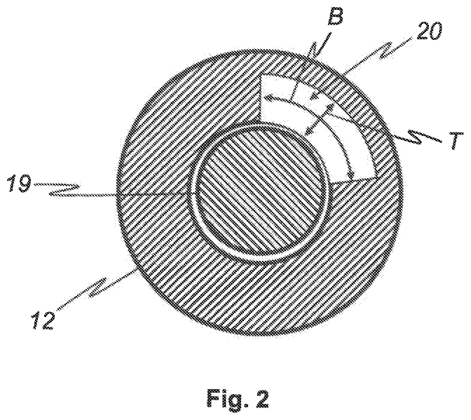

FIG. 2 shows a schematic cross-section through a sleeve according to the invention;

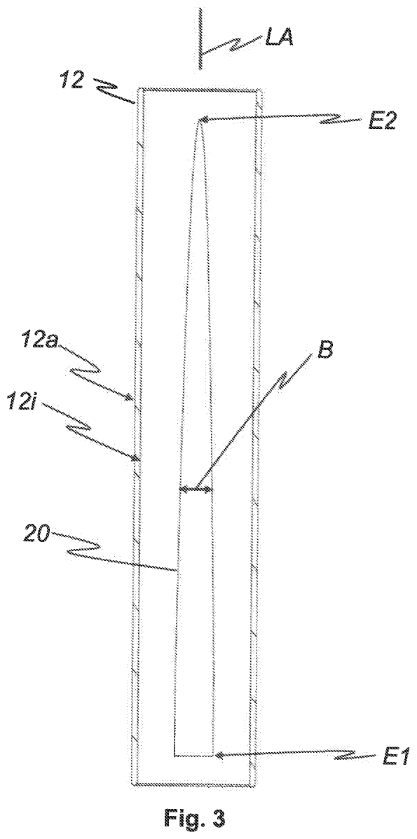

FIG. 3 shows a schematic longitudinal section through a further sleeve according to the invention;

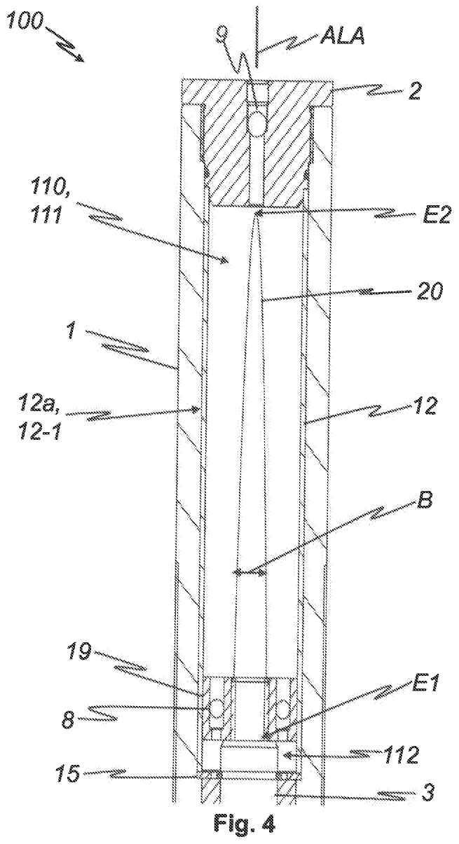

FIG. 4 shows a schematic longitudinal section through a damper according to the invention;

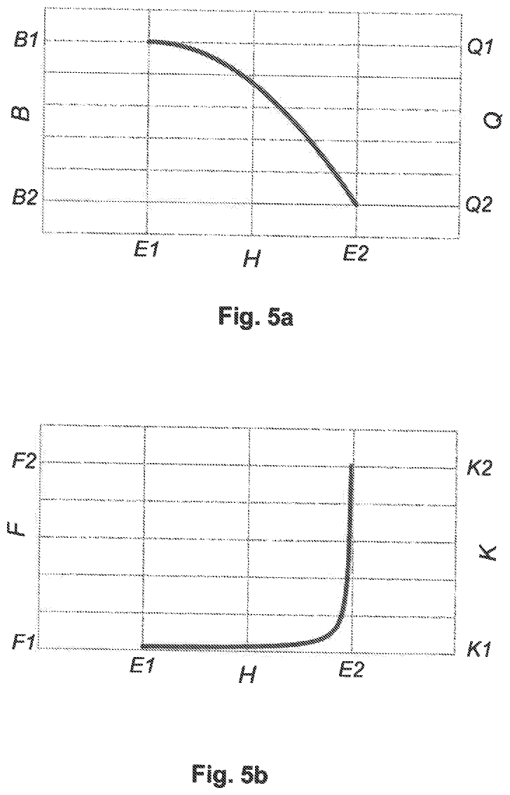

FIG. 5 shows exemplary progressions of the width of a recess of a sleeve according to the invention and a resulting flow impedance and

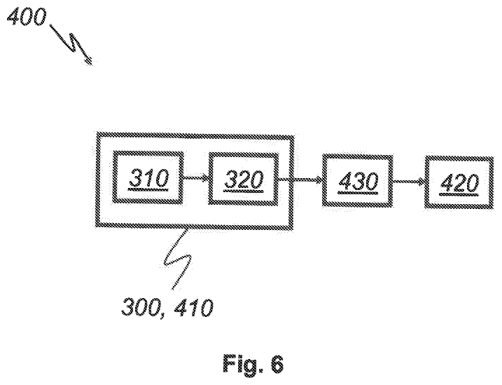

FIG. 6 shows a schematic representation of a production method according to the invention.

FIG. 1 shows a schematic longitudinal section through a sleeve 12 according to the invention. The illustrated sleeve 12 has the shape of a hollow cylinder with a longitudinal axis LA. On an inner surface 12i the sleeve 12 has a recess 20, which together with a piston 19 guided in the sleeve 12 defines a flow channel for a damping fluid between a first fluid chamber 111 of a damping space of a damper 100 and a second fluid chamber 112. The recess-free region of the inner surface 12i forms a guide face 12-19 for guiding the piston 19, and the piston 19 preferably bears on this guide face in a fluid-tight manner. An outer surface 12a of the sleeve 12 can form a contact surface for mechanical and/or thermal connection of the sleeve 12 to an outer body (not illustrated) of the damper 100.

The illustrated recess 20 is modulated along the longitudinal axis LA for setting the flow impedance for the damping fluid, for example in that a first region of the recess 20 has a first depth T1 orthogonal to the longitudinal axis LA and a second region of the recess has a greater second depth T2. If the piston 19 is located in the region of the first depth T1 (FIG. 1a), as a result a flow channel is defined which has a smaller flow cross-section and thus a higher flow impedance than if the piston 19 is located in the region of the second depth T2 (see FIG. 1b). Consequently the flow impedance for the damping fluid and consequently the damping force of the damper 100 is dependent upon the position of the piston 19 along its travel path inside the sleeve 12.

FIG. 2 shows a schematic cross-section through a sleeve 12 according to the invention. The sleeve 12, which for example has a hollow cylindrical shape, comprises on an inner surface a recess 20, which together with a piston 19 guided in the sleeve 12 defines a flow channel for a damping fluid. The flow impedance for the damping fluid in the flow channel can be set by the choice of a depth T of the recess 20 in a radial direction of the sleeve 12 and/or a width B of the recess 20 in a circumferential direction of the sleeve 12.

FIG. 3 shows a schematic longitudinal section through a further sleeve 12 according to the invention. The illustrated sleeve 12 is hollow cylindrical with a longitudinal axis LA and comprises at least one recess 20, which is constructed as a continuous opening from an inner surface 12i to an outer surface 12a of the sleeve 12, so that the depth of the recess 20 corresponds to a wall thickness of the sleeve 12. The sleeve preferably comprises four recesses 20 which are uniformly distributed about the longitudinal axis LA and/or are of the same kind. A width B of the recess in a circumferential direction of the sleeve 12 decreases along the longitudinal axis LA from a first end E1 of the recess 20 to a second end E2 of the recess 20, so that the recess 20 in a wall plane of the sleeve 12 for example describes a parabolic shape.

FIG. 4 shows a schematic longitudinal section through a damper 100 according to the invention. The illustrated damper 100 comprises a hollow cylindrical outer body 1 with a longitudinal axis of the outer body ALA. The sleeve 12 illustrated in FIG. 3 is arranged in the outer body 1 in such a way that the longitudinal axis of the sleeve 12 coincides with the longitudinal axis of the outer body ALA and an outer surface 12a of the sleeve forms a contact surface 12-1 for mechanical and/or thermal connection to the outer body 1. The sleeve 12 is fixed releasably in the outer body 1 by a closure 2 and a passage 15 for a piston rod 3. The inner space of the sleeve 12 forms the damping space 110 of the damper 100, which can be filled with a damping fluid through a filling valve 9 in the closure 2. In the illustrated example the piston 19 of the damper 100 is located at the first end E1 of the recess 20 of the sleeve 12 in the damping space 110.

If the piston rod 3 is pressure-loaded, as a result the piston 19 is pushed along its travel path from the first end E1 to the second end E2 of the recess 20. In this case the damping fluid flows from a first fluid chamber 111 in the direction of movement in front of the piston 19 through the flow channel defined by the recess 20 with the outer body 1 and the piston 19 into a second fluid chamber 112 behind the piston 19. The flow impedance occurring in this case for the damping fluid determines the damping force of the damper 100. Since the width B of the illustrated recess 20 decreases from the first end E1 to the second end E2, the flow cross-section of the flow channel also decreases if the piston, on its travel path along the longitudinal axis of the outer body ALA, moves from the first end E1 to the second end E2. Consequently the flow impedance for the damping fluid and the damping force increase over the travel path H if the piston moves from the first end E1 to the second end E2.

In order that, when the piston rod 3 is relieved of load, the piston 19 can be easily returned into its illustrated initial position, a number of non-return valves 8 can be provided in the piston 19. Due to the non-return valves 8 the damping fluid can flow with low flow impedance from the second fluid chamber 112 into the first fluid chamber 111 while the piston 19 moves from the second end E2 back to the first end E1.

FIG. 5 shows exemplary progressions of the width B of a recess 20 of a sleeve 12 (FIG. 5a) according to the invention and a flow impedance F (FIG. 5b) resulting therefrom. The sleeve 12 of the damper 100 illustrated in FIG. 4 shows for example a recess 20 having a width B which decreases steadily from a first width B1 at the first end E1 of the recess 20 over the travel path H of the piston to a second width B2 at the second end E2 of the recess 20. Proportionally to the width B, the flow cross-section Q of the flow channel defined by the recess 20 with the piston 19 also decreases if the piston 19 moves along its travel path H from the first end E1 to the second end E2.

The flow impedance F is inversely proportional to the flow cross-section Q and therefore shows the increasing progression from a first flow impedance F1 to a second flow impedance F2 illustrated in FIG. 5b if the piston 19 moves along its travel path H from the first end E1 to the second end E2. Since the damping force K of the damper 100 is determined by the flow impedance F, the damping force K shows qualitatively the same progression as a function of the travel path H as the flow impedance F. By corresponding configuration of the recess 20 almost any progressions of the damping force K as a function of the travel path can be set.

FIG. 6 shows a schematic representation of a production method 400 according to the invention for a damper 100 according to the invention. The production method 400 comprises the manufacture 410 of a number of sleeves, in particular different from one another, for example by a method of manufacture 300 according to the invention. The method of manufacture 300 according to the invention comprises the introduction 310 of a recess in the sleeve, which can be followed by reworking 320 of the sleeve, for example deburring, in particular in the region of the recess.

The illustrated method of production 400 comprises selection 430 of a sleeve from a number of sleeves which differ in particular with respect to the flow impedance for the damping fluid between the first fluid chamber and the second fluid chamber of the damper 100. Next the installation 420 of the sleeve in the outer body of the damper 100 takes place, for example in that the sleeve 12 is inserted into the outer body, in particular with a precise fit, and is fastened there by locking means (not illustrated) such as a closure.

Features which are illustrated in the context of an example can also be combined differently according to the invention.

### LIST OF REFERENCES

1 outer body
2 closure
3 piston rod
8 non-return valve
9 filling valve
12 pressure sleeve
12a outer surface
12b inner surface
12-1 contact surface
12-19 guide face
19 piston
100 damper
110 damping space
111 first fluid chamber
112 second fluid chamber
300 method of manufacture
310 introduction
320 reworking
400 method of production
410 manufacturing
420 installing
430 selecting
ALA longitudinal axis of the outer body
B width
B1 first width
B2 second width
E1 first end
E2 second end
F flow impedance
F1 first flow impedance
F2 second flow impedance
H travel path
K damping force
K1 first damping force
K2 second damping force
LA longitudinal axis
Q flow cross-section
Q1 first flow cross-section
Q2 second flow cross-section
T depth
T1 first depth
T2 second depth

1-11. (canceled)

12: A substantially tubular sleeve for a damper, in particular a industrial shock absorber, wherein the sleeve is configured to be arranged in a damping space of the damper containing a damping fluid and comprises at least one recess at least in an inner face of the sleeve, wherein the recess defines a flow channel for the damping fluid for adaptation of the flow impedance (F) for the damping fluid at least in a direction along a longitudinal axis (LA) of the sleeve, wherein a width of the recess along the longitudinal axis increases parabolically from one end of the recess to the other end of the recess.

13: The sleeve according to claim 12, wherein the recess
a. is modulated along the longitudinal axis (LA) in order to set the flow impedance (F), wherein the recess is preferably
i. modulated with respect to a shape and/or surface of a cross-section orthogonally to the longitudinal axis (LA), particularly preferably with respect to a width (B) in a circumferential direction of the sleeve and/or a depth (T) in a radial direction of the sleeve;
ii. modulated with respect to a position of the recess in a circumferential direction of the sleeve and/or
iii. actively modulated with respect to a surface composition and/or surface morphology with a flow-dynamic effect;
b. has a depth (T) in a radial direction of the sleeve which is less than the wall thickness of the sleeve in the same region of the sleeve and/or
c. comprises at least one flow-dynamically effective coating.

14: The sleeve according to claim 12, wherein the sleeve
a. is designed in its structure, in particular with respect to a wall thickness of the sleeve and/or a material of the sleeve, to provide more savings on material than necessary with respect to the mechanical and/or thermal load-bearing capacity in the damping operation of the damper, wherein preferably on an outer surface of the sleeve a number of contact surfaces are provided for diverting mechanical and/or thermal load into a damper, particularly preferably uniformly distributed over the outer surface of the sleeve;
b. comprises a metal, preferably a steel, a plastic and/or a composite material;
c. comprises, on an inner surface of the sleeve, at least one coating, preferably for setting a friction behaviour relative to a piston of the damper, and/or
d. comprises, on at least one end face of the sleeve, a closure element which closes the interior of the sleeve at one end, preferably in a fluid-tight manner.

15: A damper, in particular an industrial shock absorber, comprising
a. a substantially tubular outer body configured to accommodate mechanical and/or thermal loads during operation of the damper;
b. a damping space in the outer body configured to accommodate a damping fluid and
c. a piston which is guided along a longitudinal axis of the outer body over a travel path (H) in the outer body, wherein the piston divides the damping space into a first fluid chamber and a second fluid chamber;
said damper further comprising a substantially tubular sleeve having at least one recess at least in an inner face of the sleeve, wherein the recess defines a flow channel for the damping fluid for adaptation of the flow impedance (F) for the damping fluid at least in a direction along a longitudinal axis (LA) of the sleeve, wherein a width of the recess along the longitudinal axis increases parabolically from one end of the recess to the other end of the recess, said substantially tubular sleeve being arranged in the damping space, wherein the sleeve is rigidly and preferably releasably connected to the outer body by a number of contact surfaces on an outer surface of the sleeve and has at least one guide surface arranged on an inner surface of the sleeve for guiding the piston over the travel path (H).

16: The damper according to claim 15, wherein a volume between the sleeve and the piston forms at least one flow channel connecting the first fluid chamber to the second fluid chamber in a fluid-conducting manner, wherein the flow channel is preferably defined by a recess in an inner surface of the sleeve and/or a groove on an outer surface of the piston.

17: The damper according to claim 16, wherein
a. the guide face interacts in a fluid-tight manner with an outer surface of the piston;
b. the guide face and/or the outer surface of the piston has a coating for increasing the thermal conductivity, for reducing friction and/or for reducing wear,
c. the contact surfaces are connected to the outer body in a thermally conductive manner and/or for mechanical transmission of force, and/or
d. the contact surfaces occupy substantially the entire outer surface of the sleeve.

18: A system for modular assembly of a plurality of dampers according to claim 16, which differ with respect to their damping characteristics, wherein
a. a number of sleeves which differ in particular with respect to the flow impedance (F) for the damping fluid between the first fluid chamber and the second fluid chamber, and
b. a number of further components of the damper, wherein the further components are standardised for each damper of the plurality of different dampers.

19: A method of manufacture for a substantially tubular sleeve for a damper, which sleeve comprises at least one recess at least in an inner face of the sleeve, wherein the recess defines a flow channel for a damping fluid for adaptation of the flow impedance (F) for the damping fluid at least in a direction along a longitudinal axis (LA) of the sleeve, wherein a width of the recess along the longitudinal axis increases parabolically from one end of the recess to the other end of the recess, wherein the method of manufacture comprises at least the introduction of a recess at least into an inner surface of the sleeve.

20: The method of manufacture according to claim 19, wherein
a. the introduction takes place by laser cutting, preferably by ultra-short pulse lasers, and/or
b. the method of manufacture comprises reworking, preferably deburring and/or surface treatment, at least of the recess.

21: A method of production for a damper, in particular industrial shock absorber, comprising
a. a substantially tubular outer body configured to accommodate mechanical and/or thermal loads during operation of the damper;
b. a damping space in the outer body configured to accommodate a damping fluid and
c. a piston which is guided along a longitudinal axis of the outer body over a travel path (H) in the outer body, wherein the piston divides the damping space into a first fluid chamber and a second fluid chamber;
said damper further comprising a substantially tubular sleeve having at least one recess at least in an inner face of the sleeve, wherein the recess defines a flow channel for the damping fluid for adaptation of the flow impedance (F) for the damping fluid at least in a direction along a longitudinal axis (LA) of the sleeve, wherein a width of the recess along the longitudinal axis increases parabolically from one end of the recess to the other end of the recess, arranged in the damping space, wherein the sleeve is rigidly and preferably releasably connected to the outer body by a number of contact surfaces on an outer surface of the sleeve and has at least one guide surface arranged on an inner surface of the sleeve for guiding the piston over the travel path (H), wherein the method of production comprises at least the manufacture of the sleeve and the installation of the sleeve into the outer body.

22: The method of production according to claim 21, wherein the manufacture of the sleeve comprises at least the introduction of a recess at least into an inner surface of the sleeve.

23: The method of production according to claim 21, wherein the method of production comprises selection of a sleeve from a number of sleeves which differ in particular with respect to the flow impedance (F) for the damping fluid between the first fluid chamber and the second fluid chamber.

24: The method of production according to claim 21, further comprising selection of a number of further components of the damper, wherein the further components are standardised for each damper of the plurality of different dampers.
